(19) United States
(12) Patent Application Publication
(10) Pub. No.: US 2005/0267843 A1
(43) Pub. Date: Dec. 1, 2005

(54) System and method for electronic deposit of third-party checks by non-commercial banking customers from remote locations

(75) Inventors: Ravi V. Acharya, Boothwyn, PA (US); Jack Kang, Bear, DE (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Bank One Corporation, Chicago, IL (US)

(21) Appl. No.: 11/195,559

(22) Filed: Aug. 2, 2005

Related U.S. Application Data
(62) Division of application No. 09/506,434, filed on Feb. 18, 2000.

(51) Int. Cl. G06F 17/60

(52) U.S. Cl. 705/42

(57) ABSTRACT

A system and method for initiating a deposit transaction, where the depositor is a non-commercial banking customer located at a remote location, and where the item to be deposited is a paper check from a third party, payable to the depositor. The enabling system features a Remote Customer Terminal (RCT) with certain input devices, connected to a bank system. The image and/or other data sent from the RCT to the Bank of First Deposit (BOFD) may be processed by conversion to Electronic Funds Transfer (EFT), via Electronic Check Presentment (ECP), or via check reconstruction. The new system and method provide convenience and improved transaction processing speed compared to other transactions that begin with a third party check.

### FIELD OF THE INVENTION

The invention relates generally to a system and method for initiating a deposit transaction, where the depositor is a non-commercial banking customer located at a remote location, and where the item to be deposited is a paper check from a third party (i.e. other than the bank customer or the paying bank), payable to the depositor.

As used herein, a “bank” may be a bank or other financial institution, and a “check” may be a check or other negotiable instrument.

### BACKGROUND OF THE INVENTION

Methods and systems for initiating electronic financial transactions from remote locations are increasingly common. Examples are the use of Automated Teller Machines (ATM's) to withdraw cash, and the use of telephonic systems and personal computers to initiate a transfer of funds between a bank customers accounts, or for electronic payment of bills. Such transactions are commonly referred to as Electronic Funds Transfer (EFT).

Two principal advantages of EFT, from the perspective of the customer, are convenience and speed. They are convenient to the extent that they do not require customers to physically visit the bank in order to initiate a financial transaction. Electronic transactions are also completed more quickly than those involving paper instruments and/or documents that must be physically routed to different locations in order to complete the transaction. A significant disadvantage of present EFT systems, however, is that they are not equipped to accept paper checks as part of the transaction. Since it is estimated that paper check volume in the United States exceeds sixty billion annually, this is a significant drawback.

Some approaches have been disclosed for converting paper checks to electronic transactions. Using an approach commonly know as Electronic Check Presentment (ECP), a bank of first deposit (the bank first receiving a paper check for deposit, hereinafter BOFD) will capture an electronic image of the check or otherwise convert the check to an electronic transaction for processing through a clearing house and the paving bank. The image of the check and/or check data essentially take the place of the paper check for the purposes of payment. For a general description of the process, see U.S. Pat. No. 5,237,159. While this method may speed transaction time, it offers no improvement in convenience for the customer who must still initiate the transaction by physically delivering the paper check to the bank.

A related approach allows a customer to write a check for purchases at the point-of-sale, typically a retail store, where the transaction is then converted into either an EFT or ECP transaction. Under this method, however, the bank customer is the payor. No provision is made for the deposit of checks by a payee.

In sum, existing systems that perform electronic banking transactions are either not equipped to handle paper checks, are configured only for bank-to-bank transactions, or do not accept third party checks for deposit. The resulting lack of convenience, and other drawbacks, limit the utility of such systems for non-commercial bank customers.

### SUMMARY OF THE INVENTION

An object of the invention is to overcome these and other drawbacks in existing methods and systems.

Accordingly, it is one object of the invention to provide a system and method for allowing non-commercial bank customers to deposit third-party checks from remote locations.

It is another object of the invention to provide a system and method that would allow bank customers to initiate such transactions at home. Such a method would be a convenience to many bank customers, and provide a new level of independence for customers who are confined to their homes due to poor health, disability, or for other reasons.

It is another object of the invention to provide a method that would allow bank customers to deposit third party checks at ATM machines. Most ATM's simply provide a means for holding paper checks until they are collected for processing. The present invention would make ATM's more useful by providing for electronic deposit of third party checks.

It is another object of the invention to provide alternative methods for the BOFD to process such transactions. By identifying a system and method for deposit that is compatible with ECP, EFT and reconstructed check processing, banks will have practical alternatives in the implementation of this new approach.

To achieve these and other objects of the invention, a payee would deposit a third party paper check using a Remote Customer Terminal (RCT) that can communicate with a BOFD system. In general terms, the RCT is equipped to “accept” paper checks. Images and/or other data from the RCT are sent to the BOFD system. The BOFD can process the transaction in several different fashions.

In the preferred embodiment of the invention, the RCT is located at home, and is a personal computer with an attached image scanner. To initiate the transaction, the customer uses an Internet-based application to access the BOFD system. A pre-assigned Personal Identification Number (PIN) allows the customer to initiate a deposit transaction. When prompted, the customer captures the image of the third-party check on the scanner, and forwards the digital image to the BOFD system. The automated system provides immediate provisional credit from the BOFD to the customer, and forwards the check image and other data to a clearing house in the form of an ECP transaction. Once the transaction has cleared the paying bank, the BOFD issues a permanent credit to the bank customer. Accordingly, the customer has initiated deposit of a third party paper check from the convenience of his/her own home, with the speed of an electronic transaction.

The following drawings and descriptions further describe the invention, including several different embodiments of the major system components and processes. The construction of such a system, implementation of such a process, and advantages will be clear to a person skilled in the art of automated financial transactions.

### BRIEF DESCRIPTION OF THE DRAWINGS

FIG. 1 is schematic diagram of the system, according to one embodiment of the invention.

FIG. 2 is a flow diagram from the perspective of a bank customer, according to one embodiment of the invention.

FIG. 3 is a flow diagram from the perspective of the BOFD system, according to one embodiment of the invention.

### DETAILED DESCRIPTION OF THE INVENTION

As indicated above, the invention is directed to a system and method for the deposit of third party checks at remote locations by non-commercial bank customers.

Overview of the System

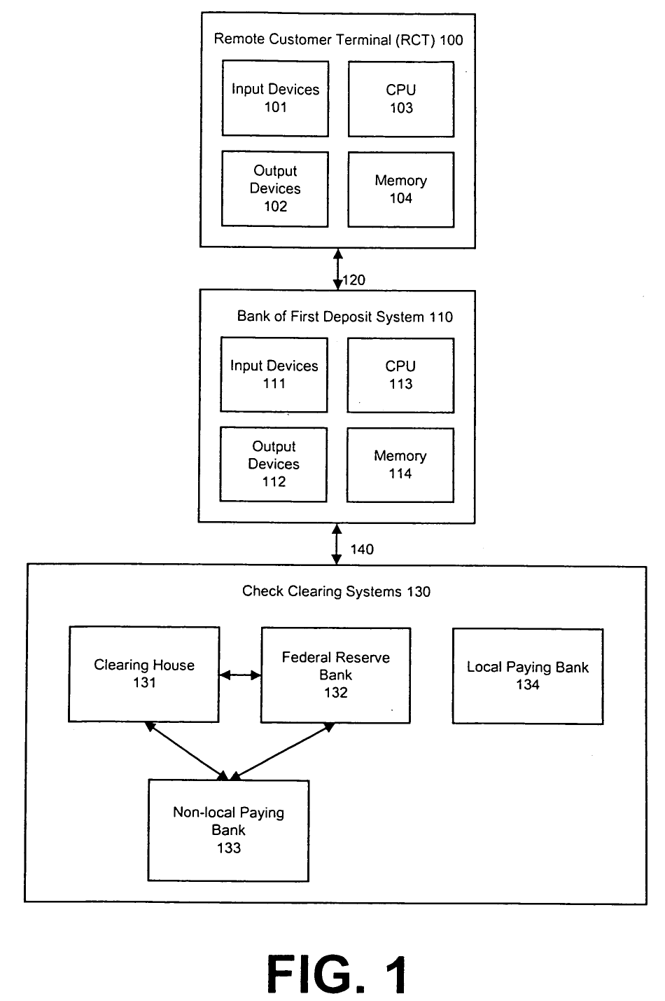

FIG. 1 is schematic diagram of the system, according to one embodiment of the invention. The key components are a Remote Customer Terminal (RCT) 100 that is connected to a Bank of First Deposit (BOFD) system 110.

The RCT 100 may be a telephone, fax machine, personal computer, ATM, or any other computer, apparatus, or system capable of collecting data and communicating with BOFD system 110.

Additionally, the RCT 100 may comprise certain input devices 101, output devices 102, Central Processing Unit (CPU) 103, and some amount of machine-readable electronic memory 104. The RCT input devices 101 may comprise a keypad, a keyboard, a microphone, a Magnetic Ink Character Reader (MICR), a Digital Image Scanner (DIS), and any other device capable of collecting data. The RCT output devices 102 may comprise a speaker, a computer display, a paper printer, and any other output device that can communicate a message to a human.

Certain software may also be stored in RCT memory 104 and executed by the CPU 103, for example, to assist in communication and data collection functions. For example, optical character recognition software may be used in conjunction with the DIS to convert machine printed characters to electronic text. Likewise, intelligent character recognition software may be used to convert handwritten characters to electronic text. Additionally, Netscape Navigator™ or Internet Explorer™ may be used as browsers for Internet communications.

The BOFD system 110 may be a telephone, facsimile machine, personal computer, mainframe computer, or any other computer, apparatus, or system capable of receiving data from the RCT, and initiating a deposit transaction. Like the RCT, the BOFD system may be comprised of input devices 111, output devices 112, CPU 113, and electronic memory 114. The BOFD system may further comprise a human operator, or it may be fully automated.

Additionally, the BOFD system is broadly defined to include such network servers or other devices necessary to perform functions such as communication, data collection, and preparation of electronic transactions. Data collection, for example, may be implemented by hosting a World Wide Web site on an Internet server.

The RCT 100 and BOFD system 110 communicate with each other via a communication link 120. The link may operate through a network, such as by direct dial connection to the Internet over a telephone network. It may be accomplished via point-to-point communication, such as with a dedicated line or via a radio frequency or microwave link.

Additionally, the BOFD system 110 may be connected to one or more check clearing systems 130 via a communication link 140. The check clearing systems may comprise for-profit clearing houses 131, Federal Reserve banks 132, and local paying banks 134. The clearing houses 131 and Federal Reserve banks 132 may in turn have means for communication with non-local paying banks 133.

As with link 120, link 140 may be accomplished through any number of schemes for networked or point-to-point communications.

The next two sections provide a description of the new method for depositing third party checks that is provided by the invention.

Overview of the Information Flow From the Customer Perspective

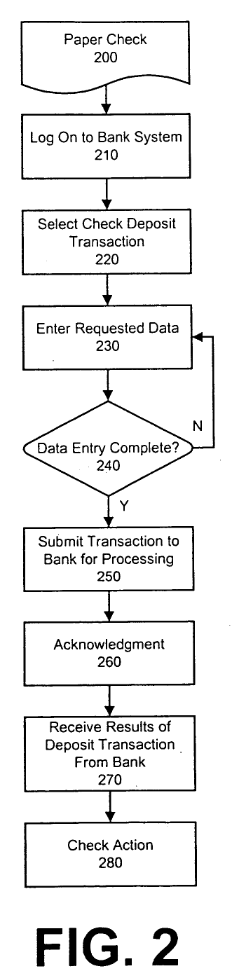

FIG. 2 is a diagram illustrating the flow of information from the perspective of a bank customer, according to one embodiment of the present invention.

The process begins when the bank customer receives a check payable to him/her 200. The check may be drawn on the customer's bank, a local bank, a non-local bank in the United States, or a foreign bank.

The customer may then “log on” to the BOFD system 110 from a RCT 100 using a Personal Identification Number (PIN), password, and/or other means of identification 210. The bank customer may then select “check deposit” from a menu of transaction options 220 as presented by the BOFD system 110.

In step 230, the customer may respond to prompts for each item of data needed to deposit the check. In another embodiment, the customer may enter a predetermined set of data all at once, for example where all data input fields are visible on a video display screen. The customer may be prompted to supply missing information in step 240. A to complete set of data may comprise customer identification, customer account number, name of payor, name and routing number of payor's bank, the amount of the check, an image of the check, and other information.

The bank customer may then submit the transaction data to the BOFD system for processing 250, and may receive acknowledgement from the BOFD system that the transaction is being processed 260.

The customer may receive a response 270 indicating, for example, that immediate provisional credit has been given, that full credit has been awarded, or that the transaction request has been denied, according to bank procedures.

If credit was issued, the paper check may be subjected to certain check actions 280 in order to prevent re-deposit of the same check. One possible check action is that the check is marked, for example, by human or machine readable ink. Alternatively, the check may be physically captured by the RCT 100, for example, via deposit into an ATM vault.

Overview of the Information Flow From the Bank Perspective

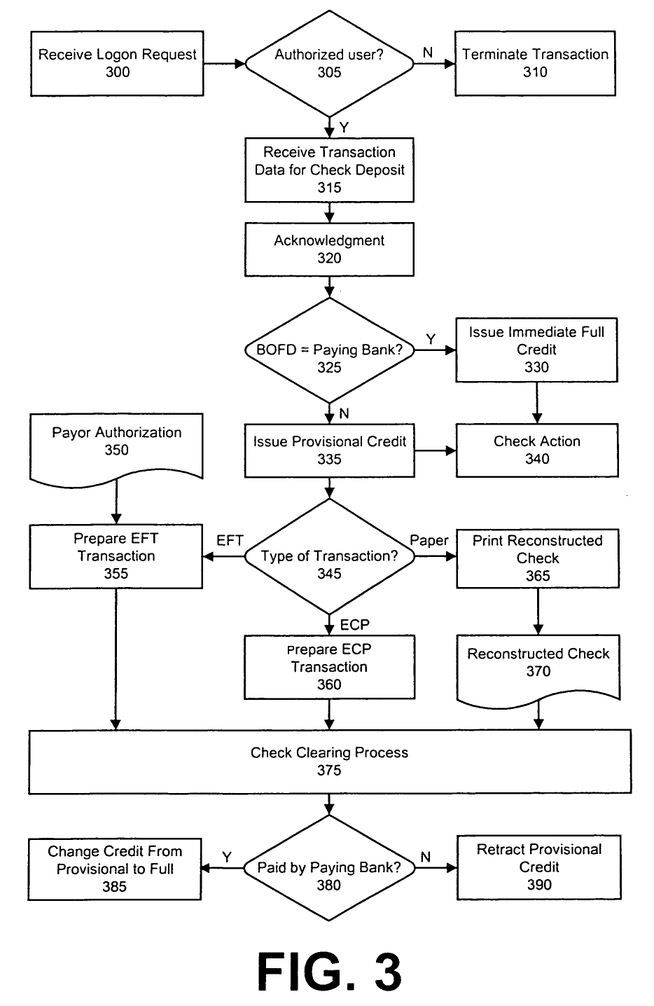

FIG. 3 is a diagram illustrating the flow of information from the perspective of the BOFD system, according to one embodiment of the invention.

The process may begin with a logon request 300. A security function 305 may terminate the process for any unauthorized user 310. An authorized user may be promoted to a data collection step, where transaction data is received 315, and an acknowledgement of receipt is sent to the customer 320.

The BOFD system may then review the identity of the paying bank 325. If the BOFD is the paying bank, the BOFD may issue immediate full credit to the account of the payee customer 330. Otherwise, the BOFD may issue “provisional” credit to the customer 335. Regardless of the type of credit issued, the BOFD system may initiate certain check actions 340 to prevent redeposit of the same check (see discussion of step 280 above). This may end the interactive session with the bank customer.

Next, the BOFD may make a decision concerning the method for “clearing” the third party check through another bank 345. If the transaction will be converted to an Electronic Funds Transfer (EFT), the BOFD may have to obtain a payor authorization 350 to support preparation of the EFT transaction 355. Alternatively, the BOFD may format the transaction for Electronic Check Presentment (ECP) 360, according to certain pre-established agreements with the paying bank. If, however, the BOFD has neither the payor's authorization for an EFT, nor an agreement with the paying bank for ECP, then the BOFD may print a reconstructed check 365.

In the case of the reconstructed check 370, the check clearing process 375 is the traditional method for physically routing the paper check to the paying bank for payment. In an EFT or ECP transaction, the check clearing process 375 may be accomplished by automated systems. The BOFD may submit the electronic transactions individually, or in batch. The check clearing process 375 may involve data transfer directly to a local paying bank, of it may involve transfer of data to a clearing house or Federal Reserve bank for ultimate credit by the paying bank.

The paying bank may issue credit for the check 380. If credit is given, the BOFD may change the customer's credit from “provisional” to “full” 385. If however, the paying bank fails to pay the check, the BOFD may retract the “provisional” credit issued earlier 390.

The specification and examples provided above should be considered exemplary only. It is contemplated that the appended claims will cover any other such embodiments or modifications as fall within the true scope of the invention.

1. A system for depositing the value associated with conventional checks into the bank account of a customer payee comprising:
an interface to a customer terminal, the customer terminal being located remotely from a bank;
an automated banking system connected to the customer terminal interface via a communication link; and
an interface to a check clearing system, the check clearing system connected to the automated banking system via a communication link, the check clearing system being located remotely from the automated banking system,
wherein the automated banking system is configured such that information from a conventional check is entered into the customer terminal, and
wherein the automated banking system and check clearing system are configured to effectuate deposit of the discrete value of each check into an account of the customer payee without physical receipt of the conventional check by the automated banking system.

2. The system of claim 1, wherein the customer terminal comprises a telephone.

3. The system of claim 1, wherein the customer terminal comprises a facsimile machine.

4. The system of claim 1, wherein the customer terminal comprises a personal computer.

5. The system of claim 1, wherein the customer terminal is an automated teller machine.

6. The system of claim 1, wherein the customer terminal comprises a keypad for data entry.

7. The system of claim 1, wherein the customer terminal comprises a keyboard for data entry.

8. The system of claim 1, wherein the customer terminal comprises a microphone for data entry.

9. The system of claim 1, wherein the customer terminal comprises a magnetic ink character reader for data entry.

10. The system of claim 1, wherein the customer terminal comprises a digital image scanner for data entry.

11. The system of claim 10, wherein the digital image scanner comprises optical recognition software to convert machine printed characters to electronic text.

12. The system of claim 10, wherein the digital image scanner comprises intelligent character recognition to convert handwritten characters to electronic text.

13. The system of claim 1, wherein the customer terminal comprises a printer for printing receipts or marking checks.

14. The system of claim 1, wherein the customer terminal includes a vault for storing the conventional checks whose associated discrete value were deposited.

15-29. (canceled)

30. The system of claim 1, wherein the automated banking system is further configured to provide a provisional credit to an account of the customer payee.

31. The system of claim 1, wherein further each conventional check is optionally subjected to one or more actions to prevent redeposit of the conventional check.

32. The system of claim 31, wherein the one or more actions comprise marking each conventional check by human or machine readable ink, physical capture of each conventional check or combinations thereof.

33. A system for depositing the value associated with conventional checks into the bank account of a customer payee comprising:
an interface to a customer terminal, the customer terminal being located remotely from a bank, the customer terminal further being selectively locatable by a customer payee;
an automated banking system connected to the customer terminal interface via a communication link; and
an interface to a check clearing system, the check clearing system connected to the automated banking system via a communication link,
wherein the automated banking system is configured such that information from a conventional check is entered into the customer terminal;
wherein the automated banking system and check clearing system are configured to effectuate deposit of the discrete value of each check into an account of the customer payee; and
wherein the automated banking system is configured to provide a provisional credit to the customer payee.

34. The system of claim 33, wherein the customer terminal comprises a telephone.

35. The system of claim 33, wherein the customer terminal comprises a facsimile machine.

36. The system of claim 33, wherein the customer terminal comprises a personal computer.

37. The system of claim 33, wherein the customer terminal comprises a keypad for data entry.

38. The system of claim 33, wherein the customer terminal comprises a keyboard for data entry.

39. The system of claim 33, wherein the customer terminal comprises a microphone for data entry.

40. The system of claim 33, wherein the customer terminal comprises a magnetic ink character reader for data entry.

41. The system of claim 33, wherein the customer terminal comprises a digital image scanner for data entry.

42. The system of claim 41, wherein the digital image scanner comprises optical recognition software to convert machine printed characters to electronic text.

43. The system of claim 41, wherein the digital image scanner comprises intelligent character recognition to convert handwritten characters to electronic text.

44. The system of claim 33, wherein the customer terminal comprises a printer for printing receipts or marking checks.

45. A system for depositing the value associated with conventional checks into the bank account of a customer payee comprising:
an interface to a customer terminal, the customer terminal being located remotely from a bank, wherein the customer payee controls access to the customer terminal;
an automated banking system connected to the customer terminal interface via a communication link, the automated banking system being located remotely from the customer terminal interface; and
an interface to a check clearing system, the check clearing system connected to the automated banking system via a communication link, the check clearing system being located remotely from the automated banking system,
wherein the automated banking system is configured such that information from a conventional check is entered into the customer terminal, and
wherein the automated banking system and check clearing system are configured to effectuate deposit of the discrete value of each check into a demand deposit account of the customer payee without physical receipt of the conventional check by the automated banking system.

46. The system of claim 45, wherein the customer terminal comprises a personal computer.

47. The system of claim 45, wherein the customer terminal comprises a digital image scanner for data entry.

48. The system of claim 47, wherein the digital image scanner comprises optical recognition software to convert machine printed characters to electronic text.

49. The system of claim 45, wherein the remote customer terminal comprises a printer for printing receipts or marking checks.

50. The system of claim 45, wherein further each conventional check is optionally subjected to one or more actions to prevent redeposit of the conventional check.

51. The system of claim 50, wherein the one or more actions comprise marking each conventional check by human or machine readable ink, physical capture of each conventional check or combinations thereof.
